(19) United States
(12) Patent Application Publication
(10) Pub. No.: US 2006/0227781 A1
(43) Pub. Date: Oct. 12, 2006

(54) Processing communication terminal addresses by integration and/or extraction of communication interface characteristics in the address

(76) Inventors: Olivier Marce, Massy (FR); Damien Galand, Chaville (FR)

Correspondence Address: SUGHRUE MION, PLLC, 2100 PENNSYLVANIA AVENUE, N.W., SUITE 800, WASHINGTON, DC, 20037, US

(21) Appl. No.: 10/562,160

(22) PCT Filed: Jun. 23, 2004
(86) PCT No.: PCT/FR04/01579

§ 371 Date: Mar. 29, 2006

(30) Foreign Application Priority Data
Jun. 27, 2003 (FR) 03/07774

(51) Int. Cl. H04L 12/56; H04L 12/28

(52) U.S. Cl. 370/392

(57) ABSTRACT

A device (D) installed in a source communication terminal (T1) of a packet-switched communication network (N) using a connectionless protocol is dedicated to processing addresses of destination communication terminals (T2). This device (D) comprises processing means (MT) responsible, when their source terminal (T1) must transmit a data packet to a destination terminal (T2) designated by an address containing information data representing at least one characteristic of its communication interface, to determine that information data and then adapt the communication parameters of their source terminal (T1) as a function of the information data that has been determined.

The invention relates to the field of the transmission of packets of data between communication terminals of a packet-switched communication network using a connectionless protocol.

In the present context, the expression “communication terminal” refers to a network equipment capable of exchanging data with other network equipments via communication equipments (or nodes) of a communication network, such as edge routers, core routers or switches. Consequently, a communication terminal could be fixed or mobile hardware, for example a telephone, computer or server.

The person skilled in the art knows that the information necessary for transmitting packets of data in a packet-switched network using a connectionless protocol, for example an IP network, is the address of the destination terminal of the packets, which is contained in the address field of the header of the packet.

That information certainly enables packets to reach a destination terminal, but does not guarantee that the packets can be processed correctly by said destination terminal. The ability of a terminal to process a data packet depends among other things on the type of communication interface to which it is connected and that enables it to contact fixed or mobile communication terminals that are the final destinations of the data contained in the packet.

For example, the size of the data packets that a communication interface can accept depends on its type. This size, which is defined by a parameter known as the maximum transmission unit (MTU) is unknown to the sender (or source) terminal, which must therefore initially transmit its packets using an arbitrary MTU. If the size of the packet received by the destination terminal is too large for its communication interface, the latter sends an Internet Control Message Protocol (ICMP) message to the equipment that sent the packet, requesting it to retransmit the packet in a fragmented form. As it still does not know the size of the MTU, the source terminal may be obliged to send the data several times in packets of increasingly smaller size, until it finds the MTU size supported by the communication interface of the destination terminal. This type of repetitive processing consumes resources to no benefit and slows down the transmission of data. In extreme situations, it may even prevent the transmission of data.

The reliability of a communication interface also depends on its type. That reliability, which may be defined by means of levels, is unknown to the sender terminal. Only the intermediate communication equipment (router or switch) that immediately precedes the destination terminal and connects it to the network knows the reliability level of its communication interface. Consequently, when packets are sent to a destination terminal, it is the intermediate communication equipment preceding it that must adapt certain management parameters of certain of its protocol stacks in order to adapt the packets received to the communication interface of the destination terminal to which it is connected. This type of processing infringes the principle of end-to-end transmission, makes the task of the intermediate communication equipment more complex and burdensome, and necessitates the mobilization of numerous internal resources.

An object of the invention is therefore to improve on the above situation.

To this end it proposes a method of processing communication terminal addresses consisting in integrating into the address of a terminal (or encoding therein) at least one characteristic of the communication interface that connects it to an intermediate communication equipment.

Thus each (source) terminal wishing to contact a (destination) terminal having an address of the above kind can obtain from that address information data representing at least one characteristic of the communication interface of the destination terminal of a data packet to be transmitted, and then configure its transmission parameters accordingly before transmitting the data packet to it.

Encoding is preferably effected by dividing the address field into sub-fields each of which receives terminal address information or a communication interface characteristic.

Any type of characteristic may be encoded in the address, and in particular the maximum transmission unit (MTU) that defines the maximum packet size supported by the communication interface and the reliability level of the communication interface.

Accordingly, when a source terminal wishes to transmit a data packet to a destination terminal designated by an address integrating information data, the information data that represents at least one characteristic of its communication interface is determined from that address, and the transmission parameters of the source terminal are then configured as a function of the information data that has been determined.

This information data is preferably determined in the source terminal seeking to transmit a data packet to a destination terminal.

For example, information data representing the reliability level of the communication interface of the destination terminal is obtained from the address of the destination terminal. In this case, the source terminal seeking to send a data packet to the destination terminal configures the time management parameters of protocols of the protocol stack belonging to the level three layer (network layer) of the open system interconnection (OSI) model as a function of the reliability level coded in the destination address contained in the address of the packet to be transmitted.

Instead of or in addition to this, information data representing the maximum transmission unit (MTU) supported by its communication interface may be obtained from the address of the destination terminal. In this case the size of the packet to transmit can be adjusted in the source terminal as a function of the maximum transmission unit (MTU) contained in the header of the data packets that it is seeking to transmit to the destination terminal.

The invention further relates to an address processing device for a communication terminal of a packet-switched communication network using a connectionless protocol.

The device is characterized in that it comprises processing means adapted, when their source terminal has to transmit a data packet to a destination terminal designated by an address containing information data representing at least one characteristic of its communication interface, to determine said information data and then to adapt the communication parameters of their source terminal as a function of said information data that has been determined.

For example, the processing means may be adapted to decode information data representing the reliability level of its communication interface in the address field of the destination terminal. In this case, the processing module of the device may comprise configuration means adapted to configure protocol time management parameters in its source terminal of the protocol stack belonging to the level three level of the OSI model as a function of the reliability level contained in the address of the packet to be transmitted.

Instead of or in addition to this, the processing means may, firstly, decode information data representing the maximum transmission unit (MTU) supported by its communication interface in the address field of the destination terminal and, secondly, adjust the size of the data packet to be transmitted as a function of the maximum transmission unit (MTU).

Moreover, the device D may be connected to a memory installed in its source terminal in which configuration data is stored in corresponding relationship to destination terminal addresses (which contain information data in coded form). In this case its processing means are adapted to extract the configuration data that corresponds to the address of the destination terminal of the data packet to be transmitted.

The invention also proposes a communication terminal equipped with a processing device of the type described hereinabove, with or without a memory establishing the correspondences between destination terminal addresses and configuration data.

The invention is particularly well adapted, although not exclusively so, to Internet Protocol (IP) communication networks, in particular IPv6 networks. In this particular case, 16 bits of the address field may be used for the information data, for example, with 10 bits of the address field for the information data representing the maximum transmission unit (MTU) and six bits of said address field for information data representing the reliability level.

Other features and advantages of the invention will become apparent on reading the following detailed description and examining the appended drawings, in which:

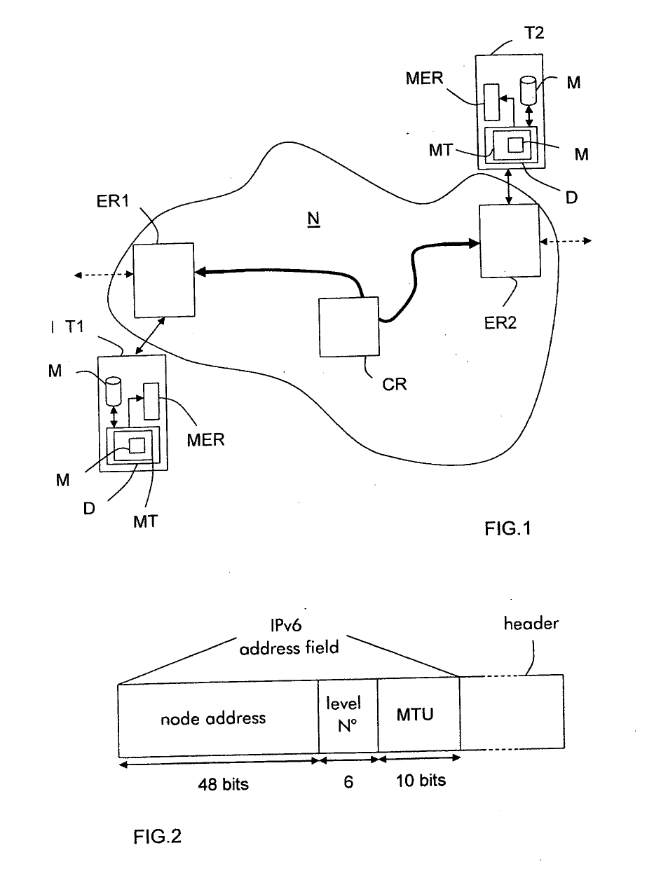

FIG. 1 is a diagram of one example of an IP network comprising communication terminals provided with a device of the invention, and

FIG. 2 is a diagram of one example of a data packet header conforming to the invention.

The appended drawings constitute part of the description of the invention as well as contributing to the definition of the invention, if necessary.

An object of the invention is to take account of communication interface characteristics of destination communication terminals in a packet-switched communication network using a connectionless protocol, for example a protocol of the Internet Protocol (IP) type.

As shown in FIG. 1, broadly speaking an Internet Protocol (IP) communication network N includes a multiplicity of communication equipments (or hosts) CR and ERi (here i=1, 2, but i may take any value). Each communication equipment constitutes a routing or switching node for directing data packets to the communication terminal Tj that is their final destination via an air or wire interface (here j=1, 2, but j may take any value greater than or equal to 2).

A communication equipment may be an edge router ERi, for example, situated at the boundary of the network N and used to set up links with other networks and/or communication terminals Tj. However, a network equipment may equally be a core router CR.

In the present context the expression communication terminal refers to fixed or mobile hardware able to exchange data with the network N, for example a telephone, computer or server.

As indicated hereinabove, each communication terminal Tj, referred to hereinafter as a terminal Tj, is connected to at least one communication interface having known characteristics that are a function of its type and which connects it to a communication equipment such a router ERi.

Those interface characteristics include in particular the size of the data packets that the communication interface can accept, which is defined by a parameter called the maximum transmission unit (MTU), and the reliability of the communication interface, which may be defined by reliability levels or rates.

According to the invention, information data representing at least one of the characteristics of its communication interface is associated with each address of a terminal Tj of the network N. Each address of a terminal Tj is preferably associated with the reliability level and the maximum packet size (MTU) supported by its communication interface. The information data is integrated into the address of the terminal Tj (or coded therein), for example using the method explained hereinafter.

The address that is integrated by a source terminal Tj (for example the terminal T1) into the address field of the header of a data packet to be transmitted to a destination terminal Tj′ (for example the terminal T2) is preferably divided into portions containing data defining the addresses of the communication equipments (or nodes) ERi providing access to the destination terminal T2, also called the destination address, or information data representing a characteristic of the communication interface of said destination terminal T2.

This is possible in packet-switched connectionless networks using the IPv6 protocol in particular. In this type of network, the header field reserved for the IPv6 address of the destination terminal T2 comprises 64 bits which may be divided as follows, for example: 48 bits for node addresses and 16 bits for information data.

For example, 10 of the 16 bits may be reserved for information data representing the maximum transmission unit (MTU) and the remaining 6 bits for information data representing the reliability level (level number).

In other words, as shown in FIG. 2, the destination address field is divided into three sub-fields, the first for the destination address, the second for the MTU and the third for the reliability level.

Of course, variants may be envisaged in which the address of the destination terminal T2 incorporates only the size of the MTU or the reliability level. In the former case, the destination address field contains only two sub-fields, one of 54 bits for the destination address and the other of 10 bits for the MTU size, for example. In the latter case, the destination address field also contains two sub-fields, one of 58 bits for the destination address and the other of 6 bits for the reliability level, for example.

Thanks to the invention, the source terminal T1 knows certain characteristics of the communication interface of the destination terminal T2 and is therefore able to configure itself accordingly.

For example if certain information data coded in the address of the destination terminal T2 represents the reliability level, the source terminal T1 may configure itself to adapt at least one of its protocol stacks, and thus the packets to be transmitted, to said reliability level of the communication interface of the destination terminal T2. This avoids the (intermediate) communication equipment ER2 of the network N that precedes the destination terminal T2 having to adapt the packet accordingly. Moreover, this does not infringe the principle of end-to-end transmission.

Each terminal Tj of the network N is preferably adapted to build its own communication address, containing its own information data, which it can then transmit to the other terminals and equipments of the network. The communication address retains the standard format, of course, and is therefore transmitted in the conventional way.

However, the coded addresses may alternatively be generated by a service terminal of the network and communicated to the terminals thereof.

Moreover, each communication terminal Tj of the network N is preferably equipped with a send/receive module MER and a processor device D.

This processor device D comprises a processor module MT which, when the terminal Tj that it equips (for example the terminal T) must transmit data to a destination terminal (for example the terminal T2), configures certain of its transmission parameters as a function of one or more characteristics of the communication interface of the destination terminal T2.

To this end, when data must be transmitted to the destination terminal T2 designated by its address, the processing module MT can proceed in two ways, according to whether its processor device D is connected or not to a memory M in which is stored a table containing the addresses of other terminals of the networks that it can contact directly or indirectly. These terminal addresses include information data representing characteristics of their respective communication interfaces stored in corresponding relationship to configuration data.

If there is no memory M, the processing module MT decodes the information data contained in the address of the destination terminal T2 and deduces the corresponding configuration data therefrom. If there is a memory M, and therefore configuration data, the processing module MT accesses the memory M to determine the configuration data that corresponds to the address of the destination terminal T2.

The processor module MT of the processor device D preferably includes a configuration module MC adapted to configure certain management parameters of the protocol stack belonging to the level three layer (network layer) of the open system interconnection (OSI) model as a function of the reliability level contained in (or designated by) the address of the destination terminal T2 designated in the header of the packet to be transmitted.

It is even more preferable if the configuration module MC configures certain time management parameters of certain protocols (for example the TCP protocols) of the protocol stock of the level two and above layers.

More generally, the configuration module MC may adapt the sending characteristics of level two (2), for example in order to adapt the transmission rate (in the case of a radio link), or of level three (3), for example the IP timers, or of levels higher than level 3, for example in order to adapt the codec as a function of the interface (in the case of the RTP).

In a variant in which the device D does not include a configuration module, it is the processor module MT that is responsible for configuration, in particular as a function of the reliability level contained (or coded) in the address of the destination equipment of the packet to be transmitted.

The processor device D of the invention, and in particular its processor module PM, its configuration module MC and the memory M, may take the form of electronic circuits, software (or electronic data processing) modules, or a combination of circuits and software.

The invention also provides a method of processing addresses of communication terminals Tj of a packet-switched communication network N using a connectionless protocol (for example an Internet Protocol (IP) network).

The latter method may in particular be executed with the aid of the processor device D and at least one of the communication terminals Tj described above. The main and optional functions and sub-functions provided by the steps of the method being substantially identical to those provided by the various means constituting the processing device D, and/or the communication terminals Tj only the steps implementing the main functions of the method according to the invention are described hereinafter.

That method consists in integrating (or encoding) in the address of a terminal Tj at least one characteristic of the communication interface that connects it to an intermediate communication equipment ERi.

Information data representing at least one characteristic of the communication interface of the destination terminal may be obtained from the address of the destination terminal in this way for each source terminal, after which the transmission parameters of the source terminal seeking to transmit data packets to the destination terminal are configured accordingly.

The invention is not limited to the processing device, communication terminal and address processing method embodiments described hereinabove by way of example only, and encompasses all variants that the person skilled in the art might envisage that fall within the scope of the following claims.

1. Method of processing addresses of communication terminals (Tj) of a packet-switched communication network (N) using a connectionless protocol, characterized in that it consists in integrating into an address of a communication terminal (Tj) information data representing at least one characteristic of a communication interface that connects it to said network (N).

2. Method according to claim 1, characterized in that the destination address field is divided into sub-fields each intended to receive terminal address information or a communication interface characteristic.

3. Method according to claim 1, characterized in that each communication interface characteristic is selected from a group comprising at least a maximum transmission unit (MTU) defining the maximum packet size supported by the communication interface and the reliability level of the communication interface.

4. Method according to claim 1, characterized in that, in the event of a request to transmit a data packet to a destination communication terminal (T2) designated by an address integrating said information data, said information data representing at least one characteristic of the communication interface of said destination terminal (T2) is determined from said address, after which transmission parameters of the communication terminal (T1) seeking to transmit data packets to the destination communication terminal (T2) are configured as a function of said information data that has been determined.

5. Method according to claim 4, characterized in that said determination is effected in each communication terminal (T1) of said network (N) responsible for transmitting said packet.

6. Method according to claim 5, characterized in that said address includes information data representing the reliability level of the communication interface of the destination terminal (T2) and protocol time management parameters of a protocol stack belonging to a level three layer of the OSI model are configured in said communication terminal (T1) having to transmit said data packet as a function of the reliability level contained in the destination address of said packet to be transmitted.

7. Method according to claim 5, characterized in that said address includes information data representing the maximum transmission unit supported by the communication interface and the size of said packet to be transmitted is adjusted in said communication terminal (T1) having to transmit said data packet as a function of the maximum transmission unit (MTU) contained in the destination address of said packet to be transmitted.

8. Address processing device (D) for a communication terminal (Tj) of a packet-switched communication network (N) using a connectionless protocol, characterized in that it comprises processing means (MT) adapted, in the presence of an address of a communication terminal (T2) of the network (N) that is the destination of a data packet to be transmitted containing information data representing at least one characteristic of its communication interface, to determine said information data and then to adapt the communication parameters of the communication terminal (T1) that they equip and which is seeking to transmit data to said destination terminal (T2) as a function of said information data that has been determined.

9. Device according to claim 8, characterized in that each communication interface characteristic is selected from a group comprising at least a maximum transmission unit (MTU) defining the maximum packet size supported by the communication interface and the reliability level of the communication interface.

10. Device according to claim 9, characterized in that said processing means (MT) are adapted to determine in said address information data representing the reliability level of the communication interface and to configure protocol time management parameters of a protocol stack belonging to a level three layer of the OSI model in said communication terminal (T1) having to transmit said data packet as a function of the reliability level contained in said address of said packet to be transmitted.

11. Device according to claim 9, characterized in that said processing means (MT), firstly, determine in said address information data representing the maximum transmission unit (MTU) supported by the communication interface and, secondly, adjust the size of said data packet to be transmitted as a function of the maximum transmission unit (MTU) contained in its header.

12. Device according to claim 8, characterized in that it is connected to a memory (M) installed in said communication terminal (T1) having to transmit said data packet and in which configuration data of the communication parameters of said communication terminal (T1) is stored in corresponding relationship to said addresses of destination communication terminals (T2) and said processing means (MT) extract from said memory (M) the configuration data stored in corresponding relationship to the address of the communication terminal (T2) that is the destination of said data packet to be transmitted so as to configure the communication parameters of said communication terminal (T1) accordingly.

13. Communication terminal (Tj) for a packet-switched communication network (N) using a connectionless protocol, characterized in that it comprises a processing device (D) according to claim 8.

14. Use of the processing method according to claim 1 in Internet protocol (IP) communication networks.

15. Use according to claim 14, characterized in that the Internet protocol communication network is of the IPv6 type.

16. Use according to claim 15, characterized in that 16 bits of the address are intended to incorporate said information data.

17. Use according to claim 16, characterized in that 10 bits of the address are intended to incorporate information data representing the maximum transmission unit (MTU).

18. Use according to either claim 16, characterized in that six bits of the address are intended to incorporate information data representing the reliability level.

19. Use of the device according to claim 8 in Internet protocol (IP) communication networks.

20. Use of the terminal according to claim 13 in Internet protocol (IP) communication networks.
